(19) United States
(12) Patent Application Publication
(10) Pub. No.: US 2022/0032767 A1
(43) Pub. Date: Feb. 3, 2022

(54) HEAT EXCHANGER MODULE FOR A MOTOR VEHICLE

(71) Applicant: Valeo Systemes Thermiques, Le Mesnil Saint Denis Cedex (FR)

(72) Inventors: Michael Lissner, Le Mesnil Saint Denis (FR); Kamel Azzouz, Le Mesnil Saint Denis (FR); Amrid Mammeri, Le Mesnil Saint Denis (FR); Sébastien Garnier, Le Mesnil Saint Denis (FR)

(73) Assignee: Valeo Systemes Thermiques, Le Mesnil Saint Denis Cedex (FR)

(21) Appl. No.: 17/280,046

(22) PCT Filed: Sep. 25, 2019
(86) PCT No.: PCT/FR2019/052243

§ 371 Date: Mar. 25, 2021

(30) Foreign Application Priority Data
Sep. 27, 2018 (FR) 1858868

(51) Int. Cl. B60K 11/04; B60K 11/08; F04D 17/04; F01P 5/06; F01P 11/10

(52) U.S. Cl. CPC B60K 11/04; B60K 11/08; F01P 11/10; F01P 5/06; F04D 17/04

(57) ABSTRACT

The invention relates to a heat exchange module (402) for a motor vehicle, comprising:
a first heat exchanger (404) comprising at least a first stage (404a) and a second stage (404b), said first heat exchanger being configured such that the first and the second stages are in fluid connection within the same cooling circuit (600) of the motor vehicle;
a ventilation device (408) comprising at least one tangential fan (410) for setting in motion an air flow (F) intended to pass through the first heat exchanger (404),
and wherein the first (404a) and second (404b) stages of the first heat exchanger (404) are arranged opposite each other, one behind the other with respect to the direction of flow of the air flow (F), so that the air set in motion by the tangential fan (410) successively passes through the first stage (404a) and then through the second stage (404b).

The subject of the invention is a heat exchange module for a motor vehicle.

The invention relates to the field of motor vehicles, and more particularly to the field of air circulation for cooling the engine and its equipment.

Motor vehicles, in particular electric motor vehicles, need to discharge the heat generated by their operation and are therefore equipped with heat exchangers. A motor vehicle heat exchanger usually comprises tubes in which a heat-transfer fluid, in particular a liquid such as water, is intended to circulate, and heat exchange elements connected to these tubes, often designated by the term “fins” or “spacers”. The fins make it possible to increase the exchange area between the tubes and the ambient air.

However, in order to increase further the heat exchange between the heat-transfer fluid and the ambient air, a ventilation device is commonly used in addition, to generate or increase an air flow directed toward the tubes and fins.

In a known manner, such a ventilation device comprises an impeller fan, also termed an axial fan.

The air flow generated by the blades of such a fan is turbulent, in particular because of the circular geometry of the impeller, and generally reaches only part of the surface of the heat exchanger (the circular region of the exchanger that faces the impeller of the fan). The exchange of heat is therefore not homogeneous across the entire surface of the tubes and of the fins.

Furthermore, when it is not necessary for the fan to be switched on (typically when the exchange of heat with nonaccelerated ambient air is enough to cool the heat-transfer fluid circulating in the exchanger), the blades partially obstruct the flow of the ambient air toward the tubes and the fins, thus impeding the circulation of air toward the exchanger and thus limiting the exchange of heat with the heat-transfer fluid.

This integration is all the more complicated in an electric vehicle, the front end of which leaves little space in which to house the vehicle cooling elements.

The invention aims to improve this type of ventilation with a tangential fan.

One subject of the invention is thus a ventilation device intended to generate an air flow passing through a heat exchanger of a motor vehicle, comprising:
at least one tangential fan for setting in motion an air flow passing through the heat exchanger,
a housing arranged to receive one or more heat exchangers, the housing being placed upstream of the tangential fan so that, in operation of the fan, air is sucked in by the fan and this sucked air first passes through the housing for the heat exchanger before passing into the tangential fan,
an upstream distributor of the sucked air, which upstream distributor is arranged to distribute the sucked air before this air passes through the housing for the heat exchanger.

Thanks to the invention, owing to the presence of the distributor, the air flow which passes through the heat exchanger(s) is relatively homogeneous, which is particularly advantageous in terms of performance. This distributor thus makes it possible to straighten the air flow entering the exchanger(s) and to distribute the air flow uniformly through the exchanger(s).

In addition, the current trend is to reduce the air intake at the front end of the vehicle, which makes it more difficult to ensure a homogeneous distribution of air over the exchanger(s). The invention makes it possible, thanks to the distributor, to ensure this homogeneous flow through the exchanger(s) even if the air intake is of reduced dimensions.

Furthermore, the fact that the tangential fan(s) is or are behind the exchanger(s) is advantageous because this or these fans are less exposed to the risk of being damaged by stones.

According to one of the aspects of the invention, the upstream distributor comprises an upstream air guide having a convergent shape, namely the cross section of this air guide decreasing progressively away from the inlet of this guide.

According to one of the aspects of the invention, this upstream air guide has a curved, in particular nonstraight, shape over its entire length. For example, this convergent shape can be substantially, at least over a portion of its length, parabolic or hyperbolic.

According to one of the aspects of the invention, this upstream air guide comprises an air inlet and is arranged so that its end opposite to the air inlet is arranged so as to be substantially adjacent to the heat exchanger which is intended to be placed in the housing.

According to one of the aspects of the invention, the air guide is arranged facing substantially the entire surface of the heat exchanger placed in the housing.

According to one of the aspects of the invention, the distributor comprises, in addition to the air guide, at least one deflector arranged in the upstream air guide and arranged to orient the air flow toward the housing for the heat exchanger.

According to one of the aspects of the invention, the distributor comprises a plurality of upstream deflectors arranged in a row, this row being in particular substantially parallel to a surface of the heat exchanger placed in the housing.

According to one of the aspects of the invention, the deflectors of the row are all identical.

According to one of the aspects of the invention, certain upstream deflectors of the row are different from one another.

According to one of the aspects of the invention, the upstream deflectors are arranged less than 5 cm, in particular less than 2 cm or less than 1 cm, from the heat exchanger.

According to one of the aspects of the invention, each deflector comprises a fin, in particular having the shape of a curve.

According to one of the aspects of the invention, each fin has a rim curved toward the housing for the heat exchanger.

According to one of the aspects of the invention, the upstream air guide comprises a common wall with the housing for the heat exchanger, this common wall being in particular an end wall of the housing for the heat exchanger.

According to one of the aspects of the invention, the ventilation device comprises a downstream air guide arranged downstream of the heat exchanger(s) arranged in the housing.

According to one of the aspects of the invention, this air guide has a divergent shape, namely the cross section of this air guide increasing progressively toward the outlet of this downstream guide.

According to one of the aspects of the invention, this downstream air guide has a curved, in particular nonstraight, shape, over its entire length. For example, this divergent shape can be substantially, at least over a portion of its length, parabolic or hyperbolic.

According to one of the aspects of the invention, this downstream air guide comprises an air outlet and is arranged so that its end opposite to the air outlet is arranged so as to be substantially adjacent to the heat exchanger which is intended to be placed in the housing.

According to one of the aspects of the invention, the downstream air guide is arranged facing substantially the entire surface of the heat exchanger placed in the housing.

According to one of the aspects of the invention, the device comprises one or more downstream deflectors arranged to orient the air flow leaving the housing for one or more heat exchangers, toward the outlet of the downstream air guide.

According to one of the aspects of the invention, the downstream deflectors of the row are all identical.

According to one of the aspects of the invention, certain downstream deflectors of the row are different from one another.

According to one of the aspects of the invention, the downstream deflectors are arranged less than 5 cm, in particular less than 2 cm or less than 1 cm, from the heat exchanger.

According to one of the aspects of the invention, each downstream deflector comprises a fin, in particular having the shape of a curve.

According to one of the aspects of the invention, each downstream fin has a rim curved toward the housing for the heat exchanger.

According to one of the aspects of the invention, the upstream and/or downstream fins are present over substantially the entire extent of the heat exchanger(s), or over a major part of this extent.

According to one of the aspects of the invention, the heat exchangers are arranged one behind the other in the direction of circulation of the air flow.

According to one of the aspects of the invention, the upstream air guide and/or the downstream air guide are formed on two different parts, in particular assembled together, for example with screws, these parts being made in particular of plastics material.

According to one of the aspects of the invention, the part on which the downstream air guide is formed is arranged to define at least one outlet channel into which the air flow circulating in the downstream air guide flows.

According to one of the aspects of the invention, the outlet channel has a Y shape so as to have two air outlet openings.

According to one of the aspects of the invention, the downstream air guide has a common partition with the outlet channel.

According to one of the aspects of the invention, the downstream air guide communicates with the outlet channel via an elbow so that the air flow which passes through this elbow can form an angle greater than 90°, in particular greater than 120°.

According to one of the aspects of the invention, the tangential fan is arranged at the outlet of the downstream air guide.

According to one of the aspects of the invention, the tangential fan is arranged in the elbow which connects the downstream air guide to the outlet channel.

According to one of the aspects of the invention, the tangential fan is arranged at an outlet opening of the outlet channel which in particular has a Y shape.

According to one of the aspects of the invention, two tangential fans are arranged in the outlet channel, each fan being at an opening of the outlet channel which has a Y shape.

According to one of the aspects of the invention, the outlet openings of the Y lead onto the rocker panel of the vehicle body.

According to one of the aspects of the invention, the ventilation device comprises, in addition to the tangential fan(s) arranged downstream of the heat exchanger(s), a tangential fan arranged upstream of this or these heat exchangers.

According to one of the aspects of the invention, this upstream fan is placed at the inlet of the upstream air guide.

According to one of the aspects of the invention, the housing for the heat exchanger is arranged so that when the ventilation device is mounted on the vehicle, the housing is inclined so that the heat exchanger(s) received in this housing is or are inclined, this inclination being in particular between 0 and 90° relative to the horizontal, the angles of 0° and 90° being excluded. This inclination is in particular between 10° and 80°, for example between 40° and 50°.

According to one of the aspects of the invention, the ventilation device comprises 1, 2 or 3 tangential fans.

According to one of the aspects of the invention, when at least two tangential fans are provided, these fans can be identical or different, in particular with different diameters.

Another subject of the invention is a heat exchange module for a motor vehicle, comprising at least:
a first heat exchanger comprising at least a first stage and a second stage, said first heat exchanger being configured so that the first stage and the second stage are in fluid connection within the same cooling circuit of the motor vehicle;
a ventilation device comprising at least one tangential fan for setting in motion an air flow intended to pass through at least the first heat exchanger,
and wherein the first and second stages of the first heat exchanger are arranged opposite to each other, one behind the other with respect to the direction of flow of the air flow, so that the air set in motion by the tangential fan successively passes through the first stage and then through the second stage of the first heat exchanger.

A tangential fan has higher pressure coefficients than an axial fan. This makes it possible to set in motion an air flow having a pressure coefficient capable of passing through several successive heat exchange surfaces. Here, each of the stages of the first heat exchanger can thus be crossed by the air flow set in motion by the tangential fan. The proposed heat exchange module is then very compact thanks to:
the reduced dimensions of the tangential fan compared with a conventional axial fan, and
the space saving, particularly in height, obtained thanks to the first and second stages arranged opposite to each other and one behind the other in the heat exchange module, compared with a single-stage exchanger associated with a conventional axial fan.

This compactness does not thereby adversely affect the cooling performance of the heat exchange module, since the heat exchange surface can be identical to a conventional single-stage exchanger. On the contrary, the cooling performance can be improved thanks to the pressure coefficients of the tangential fan, which are higher than an axial fan.

This compactness of the proposed heat exchange module allows easier integration into the motor vehicle, in particular when the latter is electric. Specifically, the opening for the grilles of electric vehicles for the passage of air does not generally occupy more than half of the latter, which makes it difficult to ensure a homogeneous distribution of air over the heat exchangers inside the electric vehicle if the heat exchange module is not compact, a difficulty encountered with the use of conventional axial fans, for example.

With the proposed heat exchange module, the shape of the exchanger and in particular of its stages can be adapted to new forms of electric vehicle grille.

According to one of the aspects of the invention, the two stages have mutually opposite faces which are crossed by the air flow during the operation of the tangential fan.

According to one of the aspects of the invention, the two stages are in contact with one another via their mutually opposite faces.

As a variant, the two stages are arranged so as to form, between their mutually opposite faces, a nonzero spacing. In other words, the two stages are not contiguous to each other.

According to one of the aspects of the invention, the two stages are arranged with a spacing between them which is smaller than 2 times the thickness of each stage, in particular smaller than the thickness of each stage, in particular smaller than half of the thickness of each stage, in particular smaller than ⅕ or 1/10 of the thickness of each stage.

According to another aspect of the invention, the first stage and the second stage of the first heat exchanger are connected to each other by at least one fluid connection allowing the heat-transfer fluid to circulate in series from one stage to the other of the first heat exchanger.

According to another embodiment, the first stage and the second stage of the first heat exchanger are respectively connected to said cooling circuit via fluid connections allowing the heat-transfer fluid to circulate in parallel in the first stage and the second stage within the cooling circuit.

According to another aspect of the invention:
the first stage comprises a first bundle of heat exchange ducts,
the second stage comprises a second bundle of heat exchange ducts,
   and wherein said first heat exchanger comprises a first common header box placed at a first end of the first and second bundles of heat exchange ducts.

According to one embodiment, said first heat exchanger additionally comprises a second common header box placed at a second end of the first and second bundles of heat exchange ducts, opposite to said first end.

Advantageously, the first and second stages have the same heat exchange surface area, for example forming stages of identical dimensions.

According to one aspect of the invention, the first and second stages are oriented parallel to one another.

According to one embodiment of the invention, the first and second stages are oriented perpendicular to the direction of flow of the air flow within the heat exchange module.

Advantageously, the first and second stages form a single heat exchanger chosen from among a condenser or a low-temperature radiator.

According to one embodiment of the invention, the ventilation device is arranged upstream of the first heat exchanger with respect to the direction of flow of the air flow, the tangential fan being configured to blow the air flow through said first heat exchanger.

According to another embodiment of the invention, the ventilation device is arranged downstream of the first heat exchanger with respect to the direction of flow of the air flow, the tangential fan being configured to suck the air flow through said first heat exchanger.

Advantageously, one of the first and second stages, termed front stage, is arranged between an opening in the front end of the motor vehicle and the other stage.

Preferably, said front stage is arranged opposite to the opening in the front end of the motor vehicle.

According to one embodiment, the heat exchange module additionally comprises at least a second heat exchanger, the at least one tangential fan being configured to set in motion the air flow through at least the first heat exchanger and through the second heat exchanger.

Advantageously, the first and second heat exchangers are arranged opposite each other, one behind the other with respect to the direction of flow of the air flow, so that the air set in motion by the tangential fan passes successively through the first heat exchanger and then through the second heat exchanger.

Advantageously, the first and second heat exchangers are respectively intended to be in fluid connection with separate cooling circuits in the motor vehicle, such as typically the air-conditioning circuit on the one hand and an engine or battery cooling circuit of the vehicle on the other hand.

According to one embodiment, the second heat exchanger comprises a single heat exchange stage.

According to another embodiment, the second heat exchanger comprises at least a first stage and a second stage, said second heat exchanger being configured so that the first stage and the second stage are in fluid connection within the same motor vehicle cooling circuit.

Advantageously, the first and second heat exchangers have the same heat exchange surface area, for example forming heat exchangers of similar dimensions.

According to one aspect of the invention, the heat exchange module comprises a fairing defining a housing arranged to receive at least said first exchanger and the tangential fan so that, in operation of the fan, the air set in motion by the fan is at least partially guided by the fairing and passes through the first heat exchanger.

Other features and advantages of the invention will become apparent from reading the following description. This description is purely illustrative and should be read in conjunction with the appended drawings, in which:

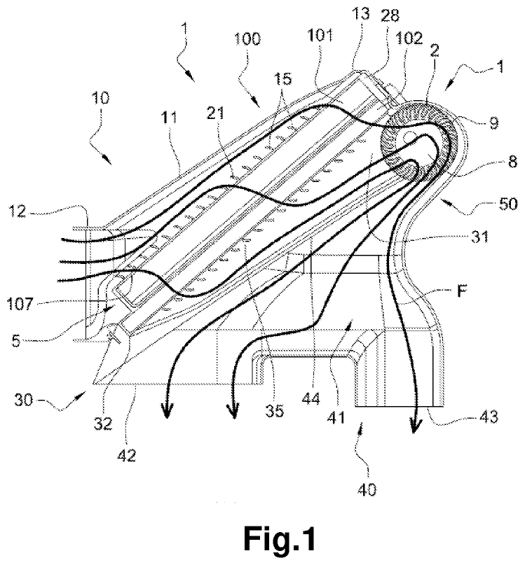

FIGS. 1 to 3 illustrate, in section, a heat exchange module equipped with a ventilation device according to various embodiments of the invention;

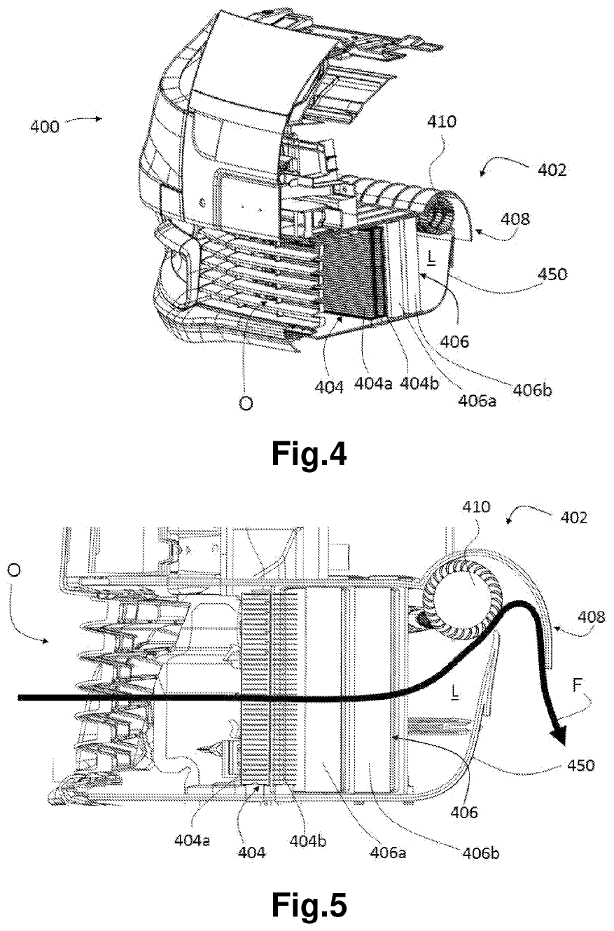

FIG. 4 shows a perspective view of a motor vehicle front end comprising an exemplary embodiment of the heat exchange module according to the invention;

FIG. 5 shows a sectional view of the exemplary embodiment of the heat exchange module of FIG. 4;

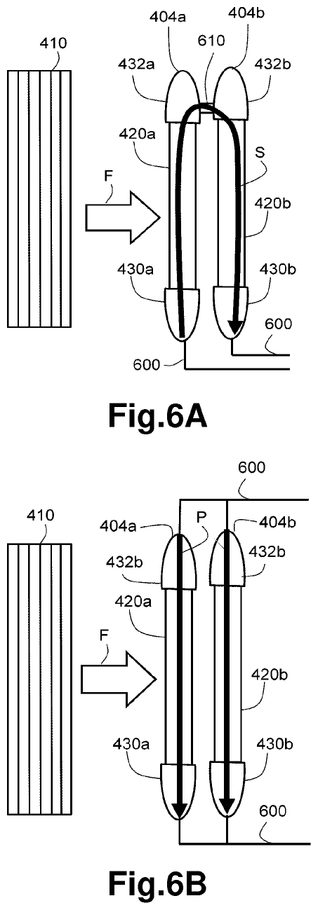

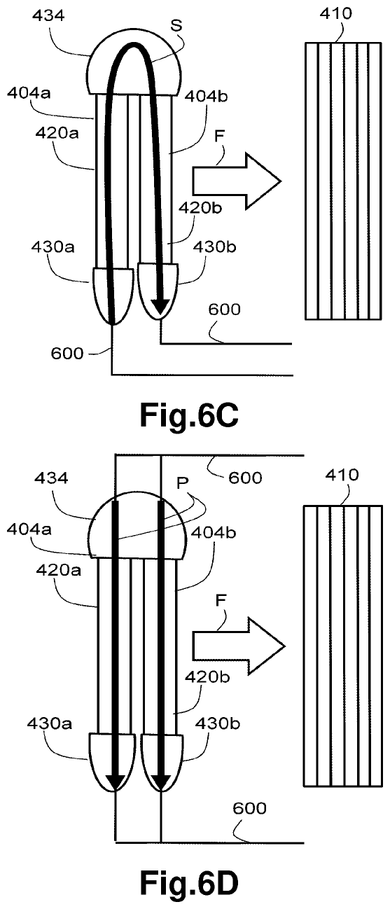

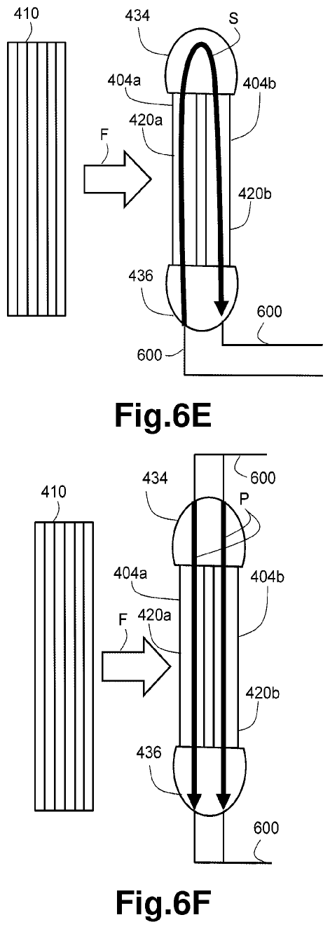

FIGS. 6A to 6F show schematic views of several exemplary embodiments of the heat exchange module, and

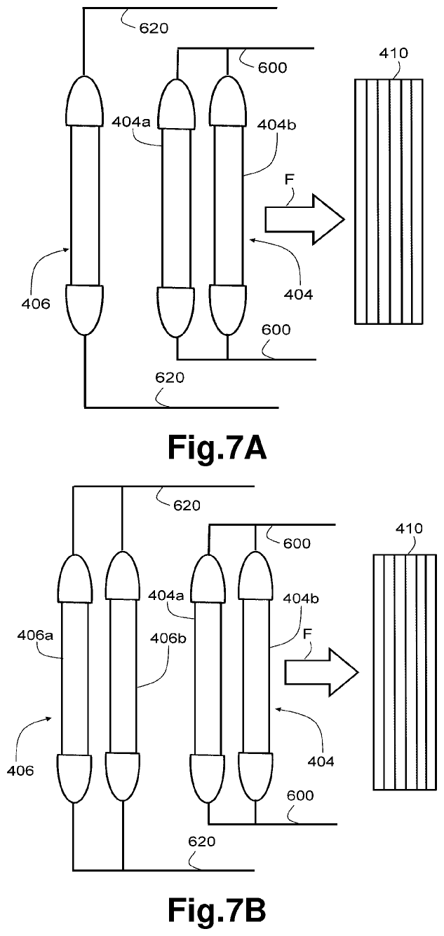

FIGS. 7A and 7B show schematic views of several exemplary embodiments of the heat exchange module with two heat exchangers.

In the various figures, identical or similar elements, having an identical or equivalent function, bear the same references. The description of their structure and function is therefore not systematically repeated.

One subject of the invention is a ventilation device 1 for a motor vehicle.

Another subject of the invention is a heat exchange module 100, comprising the ventilation device 1 and two heat exchangers 101 and 102 placed one behind the other, as illustrated in FIG. 1.

The exchangers 101 and 102 are, for example, a low-temperature radiator and an air-conditioning loop condenser.

The ventilation device 1 comprises:
a tangential fan 2 for setting in motion an air flow F passing through the heat exchangers 101 and 102,
a housing 5 arranged to receive the heat exchangers 101 and 102, the housing 5 being placed upstream of the tangential fan 2 so that, in operation of the fan 2, air is sucked in by the fan 2 and this sucked air first of all passes through the housing 5 for the heat exchanger before passing into the tangential fan 2,
an upstream distributor 10 for the sucked air, which upstream distributor is arranged to distribute the sucked air before this air passes through the housing 5 for the heat exchangers.

The fan 2 is equipped with a rotor 8 in the form of a drum, which comprises curved blades 9 at its circumference.

The upstream distributor 10 comprises an upstream air guide 11 having a convergent shape, namely the cross section of this air guide decreasing progressively away from the inlet 12 of this guide.

This upstream air guide 11 has a curved, in particular nonstraight, shape over its entire length. For example, this convergent shape can be substantially, at least over a portion of its length, parabolic or hyperbolic.

This upstream air guide 11 has an air inlet 12 and is arranged so that its end 13 opposite to the air inlet 12 is arranged so as to be substantially adjacent to the heat exchanger 101 which is placed in the housing 5.

The air guide 11 is arranged facing substantially the entire surface of the heat exchanger 101 placed in the housing.

The distributor 10 comprises, in addition to the air guide 11, deflectors 15 arranged in the upstream air guide 11 and arranged to orient the air flow F toward the housing 5 of the heat exchangers 101 and 102.

The distributor 10 comprises a plurality of upstream deflectors 15 arranged in one or more rows, this or these rows being in particular substantially parallel to a surface 107 of the heat exchanger 101.

The deflectors 15 of the row are all identical.

According to one of the aspects of the invention, the upstream deflectors are arranged less than 5 cm, in particular less than 2 cm or less than 1 cm, from the heat exchanger.

According to one of the aspects of the invention, each deflector 15 comprises a fin 21, in particular having the shape of a curve.

Each fin 21 has a rim 22 curved toward the housing 5.

The upstream air guide 10 comprises a common wall 28 with the housing for the heat exchanger, this common wall 28 being in particular an end wall of the housing 5.

The ventilation device 2 comprises a downstream air guide 30 arranged downstream of the heat exchangers 101 and 102 arranged in the housing 5.

This air guide 30 has a divergent shape, namely the cross section of this air guide increasing progressively toward the outlet 31 of this downstream guide.

This downstream air guide 30 has a curved, in particular nonstraight, shape over its entire length. For example, this divergent shape can be substantially, at least over a portion of its length, parabolic or hyperbolic.

This downstream air guide 30 has an air outlet 31 and is arranged so that its end 32 opposite to the air outlet 31 is arranged so as to be substantially adjacent to the heat exchanger which is intended to be placed in the housing.

The downstream air guide 30 is arranged facing substantially the entire surface of the heat exchanger 102 placed in the housing 5.

The device 1 comprises several downstream deflectors 35 arranged to orient the air flow leaving the housing 5 toward the outlet 31 of the downstream air guide.

The downstream deflectors 35 of the row are all identical.

According to one of the aspects of the invention, the downstream deflectors are arranged less than 5 cm, in particular less than 2 cm or less than 1 cm, from the heat exchanger.

Each downstream deflector 35 comprises a fin, in particular having the shape of a curve.

Each downstream fin 35 has a rim curved toward the housing for the heat exchanger.

The upstream 15 and/or downstream 35 fins are present over substantially the entire extent of the heat exchanger(s).

The heat exchangers 101 and 102 are arranged one behind the other in the direction of circulation of the air flow.

The upstream air guide 10 and the downstream air guide 30 are formed on two different parts, in particular assembled together, for example with screws, these parts being made in particular of plastics material.

The part 40 on which the downstream air guide 30 is formed is arranged to define at least one outlet channel 41 into which the air flow F circulating in the downstream air guide F flows.

The outlet channel 41 has a Y shape so as to have two air outlet openings 42 and 43.

The downstream air guide 30 has a common partition 44 with the outlet channel 41.

The downstream air guide 30 communicates with the outlet channel 41 via an elbow 50 so that the air flow F which passes through this elbow 50 can form an angle greater than 90°, in particular greater than 120°.

The tangential fan 2 is arranged at the outlet 31 of the downstream air guide 30.

The tangential fan 2 is arranged in the elbow 50, which connects the downstream air guide 30 to the outlet channel 41.

In the example of the figure, a single tangential fan 2 is provided.

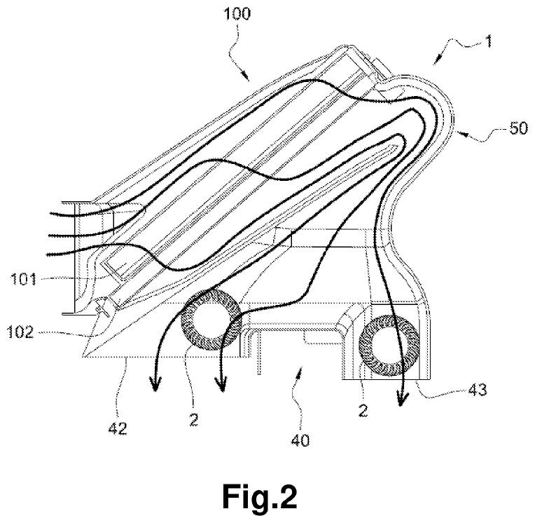

As a variant, as illustrated in FIG. 2, two tangential fans 2 are arranged in the outlet channel, each fan 2 being at an opening 42, 43 of the outlet channel 41 which has a Y shape.

These outlet openings 42 and 43 of the Y lead onto the rocker panel of the vehicle.

In the example of FIG. 2, two fans 2 are provided. None is arranged in the elbow 50.

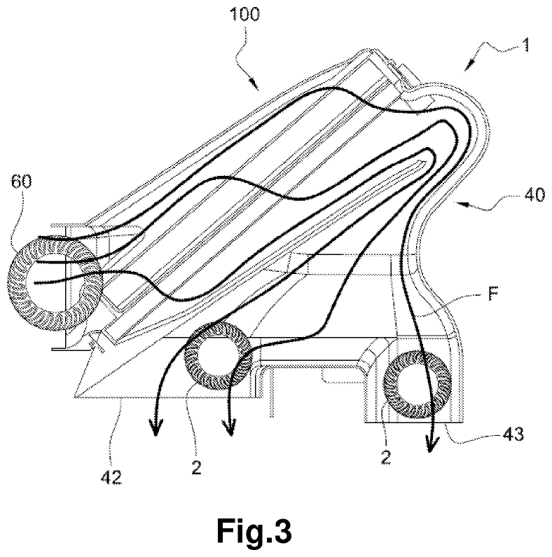

As illustrated in FIG. 3, the ventilation device 1 comprises, in addition to the tangential fans 2 arranged downstream of the heat exchangers, a tangential fan 60 arranged upstream of these heat exchangers.

This upstream fan 60 is arranged at the inlet 12 of the upstream air guide 10.

According to one of the aspects of the invention, the housing 5 for the heat exchanger is arranged so that when the ventilation device is mounted on the vehicle, the housing 5 is inclined so that the heat exchangers 101 and 102 received in this housing 5 are inclined, this inclination being in particular between 0 and 90° relative to the horizontal, the angles of 0° and 90° being excluded. This inclination is in particular between 10° and 80°, for example between 40° and 50°.

The fins can be formed on a dedicated part or, as a variant, be formed with the associated air guide.

Reference is now made to FIGS. 4 and 5 in which a vehicle front end 400 is illustrated. This exemplary embodiment presents a front end 400 of an electric vehicle, provided with at least one grille opening O so that outside air can penetrate toward the interior of the vehicle. This front end 400 is provided with a heat exchange module 402 which comprises:
a first heat exchanger 404 comprising at least a first stage 404a and a second stage 404b, the first heat exchanger being configured so that the first stage 404a and the second stage 404b are in fluid connection within the same cooling circuit of the motor vehicle;
a ventilation device 408 comprising at least one tangential fan 410 for setting in motion an air flow F intended to pass through at least the first heat exchanger 404.

The first stage 404a and the second stage 404b of the first heat exchanger 404 are arranged opposite to each other, one behind the other with respect to the direction of flow of the air flow F, so that the air set in motion by the tangential fan 410 successively passes through the first stage 404a and then through the second stage 404b of the first heat exchanger 404.

The use of the tangential fan 410 to successively supply at least two stages 404a, 404b of the same exchanger 404 makes it possible to save space, in particular in height, compared with a heat exchange module carrying a single-stage heat exchanger supplied by an axial fan.

In a first embodiment, the two stages 404a and 404b can be in contact with each other via their mutually opposite faces.

In a second embodiment, the two stages 404a and 404b are arranged so as to form, between their mutually opposite faces, a nonzero spacing. In other words, the two stages are not contiguous to each other. More particularly, the two stages 404a and 404b are arranged with a spacing between them which is smaller than 2 times the thickness of each stage, in particular smaller than the thickness of each stage, in particular smaller than half of the thickness of each stage, in particular smaller than ⅕ or 1/10 of the thickness of each stage.

In addition, the ventilation device 408 can be configured so as to supply air to a second heat exchanger 406 which can be single-stage or else can have at least two stages 406a and 406b, as described below with reference to FIGS. 7A and 7B.

The heat exchange module 402 may additionally comprise a fairing 450 defining a housing L arranged to receive at least the first exchanger 404 and the tangential fan 410 so that, in operation of the fan, the air set in motion by the fan is at least partially guided by the fairing and passes through the first heat exchanger.

The fairing can additionally be shaped to receive the second exchanger 406 and/or one or more additional tangential fans.

Among one of the first and second stages 404a, 404b, one of them, termed front stage, can be arranged between the opening O in the front end of the motor vehicle and the other stage.

The front stage may in particular be placed opposite the opening O in the front end of the motor vehicle.

FIGS. 6A to 6F schematically show various possible embodiments of the heat exchange module 402.

In FIG. 6A for example, the first stage 404a and the second stage 404b of the first heat exchanger 404 are fluidically connected to each other by at least one fluid connection 610 allowing the heat-transfer fluid to circulate in series from one stage to the other of the first heat exchanger 404 (direction of flow of the heat-transfer fluid within the first exchanger 404 according to the arrow S).

Each stage of the heat exchangers 404 and 406 may comprise at least one bundle of heat exchange ducts which may, for example, be formed by tubes or plates, in which the heat-transfer fluid, in particular a liquid such as water, is intended to circulate, cooperating with heat exchange elements such as spacers or fins. The spacers or fins make it possible to increase the exchange area between the tubes and the ambient air.

Typically, the first stage 404a comprises a bundle of tubes 420a in fluid connection with a first header box 430a arranged at a first end of the bundle 420a, and with a second header box 432a arranged at a second end, opposite to said first end. The second stage 404b comprises, for example, a bundle of tubes 420b in fluid connection with a first header box 430b at a first end of the bundle 420b, and with a second header box 432b at a second end, opposite to said first end.

The fluid connection 610 can in particular be configured to establish a fluid connection between a header box 430a, 432a of the first stage 404a and a header box 430a, 432b of the second stage 404b.

It should be noted that the first stage 404a and the second stage 404b are in fluid connection within the same cooling circuit 600 of the motor vehicle.

In FIG. 6B, the first stage 404a and the second stage 404b of the first heat exchanger 404 are respectively connected to the cooling circuit 600 via fluid connections allowing the heat-transfer fluid to circulate in parallel in the first stage 404a and the second stage 404b within said cooling circuit 600 (direction of flow of the heat-transfer fluid within the first exchanger 404 according to the arrow P).

FIGS. 6C and 6D correspond respectively to FIGS. 6A and 6B in a variant embodiment for which the first heat exchanger 404 comprises a first common header box 434 placed at a first end of the first and second bundles of heat exchange ducts 420a, 420b.

FIGS. 6E and 6F correspond respectively to FIGS. 6C and 6D in a variant embodiment for which the first heat exchanger 404 additionally comprises a second common header box 436 placed at a second end of the first and second bundles of heat exchange ducts 420a, 420b, opposite to said first end.

In the exemplary embodiments illustrated, the first and second stages 404a, 404b have the same heat exchange surface area, for example forming stages of identical dimensions. Nevertheless, according to other possible variant embodiments, each stage may have its own dimensions, for example to meet specific cooling needs or to meet integration and size constraints in the vehicle.

The first and second stages 404a, 404b can in particular be oriented parallel to each another. They can additionally be oriented perpendicular to the direction of flow of the air flow F within the heat exchange module 402.

The first and second stages 404a, 404b form a single heat exchanger 404, preferably chosen from among a condenser or a low-temperature radiator. In the case of a condenser, the exchanger 404 is intended to be placed in fluid connection with the air-conditioning circuit for example, and in the case of a low-temperature heat exchanger, the exchanger 404 is intended to be placed in fluid connection with a cooling circuit of the vehicle, for example that of the battery when the latter the vehicle is electric, for example.

In FIGS. 6A, 6B, 6E, 6F, the ventilation device 408 is arranged upstream of the first heat exchanger 404 with respect to the direction of flow of the air flow F, the tangential fan 410 then being configured to blow the air flow F through said first heat exchanger 404.

According to another possible embodiment, as illustrated in FIGS. 6C and 6D, the ventilation device 408 is arranged downstream of the first heat exchanger 404 with respect to the direction of flow of the air flow F, the tangential fan 410 then being configured to suck the air flow through said first heat exchanger 404.

Reference is now made to FIGS. 7A and 7B. In this exemplary embodiment, the heat exchange module comprises at least a second heat exchanger 406, the at least one tangential fan 410 being configured to set in motion the air flow F through at least the first heat exchanger 404 and through the second heat exchanger 406.

The first 404 and second 406 heat exchangers can in particular be arranged opposite to each other, one behind the other with respect to the direction of flow of the air flow F, so that the air set in motion by the tangential fan 410 successively passes through the first heat exchanger 404 and then through the second heat exchanger 406.

The first 404 and second 406 heat exchangers are respectively intended to be placed in fluid connection with separate cooling circuits 600, 620 in the motor vehicle. Typically, when the first exchanger 404 is a condenser, the exchanger 404 is intended to be placed in fluid connection with the air-conditioning circuit 600 for example, and when the second exchanger 406 is a low-temperature radiator, the exchanger 406 is intended to be placed in fluid connection with the battery cooling circuit 620 of the vehicle when the latter is electric, for example.

In the example illustrated in FIG. 7A, the second heat exchanger 406 comprises a single heat exchange stage.

In the example illustrated in FIG. 7B, the second heat exchanger 406 comprises at least a first stage 406a and a second stage 406b, said second heat exchanger 406 being configured so that the first stage 406a and the second stage 406b are in fluid connection within the same cooling circuit 620 of the motor vehicle.

In the exemplary embodiments illustrated, the first and second heat exchangers 404, 406 have the same heat exchange surface area, for example forming heat exchangers of similar dimensions. Nevertheless, according to other possible variant embodiments, each exchanger may have its own dimensions, for example to meet specific cooling needs or to meet integration and size constraints.

The invention is not limited to the exemplary embodiments presented, and further embodiments will be clearly apparent to a person skilled in the art. In particular, the various examples can be combined, provided they are not contradictory.

1. A heat exchange module for a motor vehicle, comprising:
a first heat exchanger having at least a first stage and a second stage, said first heat exchanger being configured such that the first stage and the second stage are in fluid connection within the same cooling circuit of the motor vehicle; and
a ventilation device comprising at least one tangential fan for setting in motion an air flow configured to pass through at least the first heat exchanger,
wherein the first and second stages of the first heat exchanger are arranged opposite each other, one behind the other with respect to the direction of flow of the air flow, so that the air set in motion by the tangential fan passes successively through the first stage and then through the second stage of the first heat exchanger.

2. The heat exchange module as claimed in claim 1, wherein the first stage and the second stage of the first heat exchanger are connected to each other by at least one fluid connection allowing the heat-transfer fluid to circulate in series from one stage to the other of the first heat exchanger.

3. The heat exchange module as claimed in claim 1, wherein the first stage and the second stage of the first heat exchanger are respectively connected to said cooling circuit via fluid connections allowing the heat-transfer fluid to circulate in parallel in the first stage and the second stage within said cooling circuit.

4. The heat exchange module as claimed in claim 1, wherein:
the first stage comprises a first bundle of heat exchange ducts,
the second stage comprises a second bundle of heat exchange ducts, and
wherein said first heat exchanger comprises a common first header box placed at a first end of the first and second bundles of heat exchange ducts.

5. The heat exchange module as claimed in claim 4, wherein said first heat exchanger comprises a second common header box placed at a second end of the first and second bundles of heat exchange ducts, opposite to said first end.

6. The heat exchange module as claimed in claim 1, wherein the first and second stages have the same heat exchange surface area forming stages of identical dimensions.

7. The heat exchange module as claimed in claim 1, wherein the first and second stages are oriented parallel to each other.

8. The heat exchange module as claimed in claim 7, wherein the first and second stages are oriented perpendicular to the direction of flow of the air flow within the heat exchange module.

9. The heat exchange module as claimed in claim 1, wherein the first and second stages form a single heat exchanger chosen from among a condenser or a low-temperature radiator.

10. The heat exchange module as claimed in claim 1, wherein the ventilation device is arranged upstream of the first heat exchanger with respect to the direction of flow of the air flow, the tangential fan being configured to blow the air flow through said first heat exchanger.

11. The heat exchange module as claimed in claim 1, wherein the ventilation device is arranged downstream of the first heat exchanger with respect to the direction of flow of the air flow, the tangential fan being configured to suck the air flow through said first heat exchanger.

12. The heat exchange module as claimed in claim 1, wherein one of the first and second stages, termed front stage, is arranged between an opening in the front end of the motor vehicle and the other stage.

13. The heat exchange module as claimed in claim 12, wherein said front stage is arranged opposite the opening in the front end of the motor vehicle.

14. The heat exchange module as claimed in claim 1, further comprising at least a second heat exchanger, the at least one tangential fan being configured to set the air flow in motion through at least the first heat exchanger and through the second heat exchanger.

15. The heat exchange module as claimed in claim 14, wherein the first and second heat exchangers are arranged opposite each other, one behind the other with respect to the direction of flow of the air flow, so that the air set in motion by the tangential fan successively passes through the first heat exchanger and then through the second heat exchanger.

16. The heat exchange module as claimed in claim 14, wherein the first and second heat exchangers are respectively configured to be placed in fluid connection with separate cooling circuits in the motor vehicle.

17. The heat exchange module as claimed in claim 14, wherein the second heat exchanger comprises a single heat exchange stage.

18. The heat exchange module as claimed in claim 14, wherein the second heat exchanger comprises at least a first stage and a second stage, said second heat exchanger being configured so that the first stage and the second stage are in fluid connection within the same cooling circuit of the motor vehicle.

19. The heat exchange module as claimed in claim 14, wherein the first and second heat exchangers have the same heat exchange surface area forming heat exchangers of similar dimensions.

20. The heat exchange module as claimed in claim 1, further comprising a fairing defining a housing arranged to receive at least said first exchanger and the tangential fan so that, in operation of the fan, the air set in motion by the fan is at least partially guided by the fairing and passes through the first heat exchanger.
